(19) United States
(12) Patent Application Publication
(10) Pub. No.: US 2010/0285311 A1
(43) Pub. Date: Nov. 11, 2010

(54) Dual component (aqueous) hybrid reactive resin system, method for production and use thereof

(76) Inventors: Norbert Steidl, Kienberg (DE); Alois Maier, Engelsberg (DE); Michael Schroers, Tacherting (DE); Roswitha Waldherr, Kienberg (DE)

Correspondence Address: FULBRIGHT & JAWORSKI, LLP, 666 FIFTH AVE, NEW YORK, NY, 10103-3198, US

(21) Appl. No.: 12/279,081

(22) PCT Filed: Apr. 3, 2007
(86) PCT No.: PCT/EP07/03009

§ 371 Date: Sep. 3, 2008

(30) Foreign Application Priority Data
Apr. 4, 2006 (DE) 10 2006 015 774.5

(51) Int. Cl. B32B 27/38; C08L 75/04; C04B 28/00; C08K 3/22; C08K 3/30; C08K 5/12; C08K 5/11; C08K 5/101; C08K 5/357; B32B 27/06; B32B 13/12

(52) U.S. Cl. 428/339; 524/590; 524/4; 524/433; 524/436; 524/423; 524/296; 524/314; 524/315; 524/96; 428/413; 428/417; 428/418; 428/341

(57) ABSTRACT

A dual component (aqueous) hybrid reactive system obtained by a) the production of an epoxy-functional (aqueous) binding agent component (I) with an epoxide equivalent of 100 to 12,500 g/eq, and average molecular mass of 200 to 25,000 Daltons and a viscosity of 1,000 to 15,000 mPas 920° C., Brookfield) and b) the production of a (latent) amino-functional hardener component (II).

The present invention relates to a two-component (aqueous) hybrid reactive resin system having improved processing properties and improved property profile, process for its preparation and the use thereof in the construction sector or industrial sector.

Owing to their property profile, epoxy-modified polyurethanes are used especially in the area of adhesives and sealants, pottings and coatings.

For use as adhesives and sealants, polyetherpolyols or polyesterpolyols are of course predominantly employed. “Synthesis and characterization of cryogenic adhesives based on epoxy-modified polyurethane resin systems” (Polymer International (1994), 35(4), 361-70) reports in detail on the synthesis of epoxy-modified polyurethanes. NCO-terminated polyurethane prepolymers are converted into epoxy-modified polyurethanes by reaction with glycidol. The property profiles of polyurethanes modified in this manner and based on PPG flexible segments of different molecular weight were emphasized with regard to mechanical properties, and adhesion at room temperature and low temperature in comparison with conventional, unmodified polyurethanes.

Epoxy-modified polyurethanes are distinguished not only by an improved property profile in comparison with conventional polyurethanes but they lead to improved properties even in mixtures with epoxy resins. Both the synthesis of epoxy-modified polyurethanes and the properties thereof in mixtures with epoxy resins with regard to adhesion, impact strength and fracture behaviour are described in Journal of Applied Polymer Science (1994), 52(8), 1137-51. Preliminary reaction of the synthesized polyurethanes with various curing agents gives systems which are distinguished by a lower degree of phase separation and improved mechanical properties.

A use of epoxy-modified polyurethanes for the finishing of textiles is described in U.S. Pat. No. 3,814,578. Glycidol-modified polyurethanes, prepared by reaction of NCO-terminated polyurethane prepolymers with glycidol, are used here. An application on wool and curing under acidic conditions leads to reduced shrinkage.

Further uses of epoxy-modified polyurethanes are explained, for example, in the following patents: Adhesives and laminated films (DE 3205733 A1), Polyurethanes (BE 620026) and Thermoplastic block polyamide-polyurethanes (DE 3504805 A1).

Common to all is the use of polyurethanes based on flexible polyols, such as, for example, polyethylene glycols, PPG, polybutadienes, polyesters, etc. A disadvantage of these materials is in particular poor resistance to chemicals and heat resistance, abrasion behaviour and mechanical load-bearing capacity. Uses as cementitious systems are not described.

Three- or four-component PCC coating systems known from the prior art and commercially available (e.g. UCrete®, Degussa Construction Chemicals GmbH) have, despite good resistance to chemicals, heat and abrasion, high mechanical load-bearing capacity and easy cleaning, a number of disadvantages in processing, in particular:
application only by trained processors
too short a processing time (about 10 min)
too short an open time (about 20 min)
excessively long curing (about 24 h)
limited formulative range
number of components
VOC content

It was therefore the object of the present invention to develop a two-component (aqueous) hybrid reactive resin system having improved processing properties and improved property profile for the preparation of coating systems which are resistant to chemicals, heat-resistant and abrasion-resistant, have a high mechanical load-bearing capacity and are easy to clean, which hybrid reactive resin system does not have said disadvantages of the prior art but has good performance characteristics and at the same time can be prepared taking into account ecological, economic and physiological aspects.

This object was achieved, according to the invention, by the provision of a two-component (aqueous) hybrid reactive resin system having improved processing properties and improved property profile, obtainable by
a) the preparation of an epoxyfunctional (aqueous) binder component (I) having an epoxide equivalent of 100 to 12 500 g/eq, an average molecular mass of 200 to 25 000 dalton and a viscosity of 1000 to 150 000 mPa·s (20° C., Brookfield),
   a₁) 5 to 300 parts by weight of a functionalized low molecular weight polyol component (A)(i), consisting of a hydroxyfunctional epoxyalcohol and/or glycidyl ether having one or more hydroxyl group(s) reactive towards isocyanate groups and one or more epoxide group(s) substantially inert to isocyanate groups, having an epoxide equivalent of 100 to 500 g/eq and a molecular mass of 50 to 1000 dalton,
   0 to 300 parts by weight of a functionalized higher molecular weight (polymeric) polyol component (A)(ii) having one or more hydroxyl group(s) reactive towards isocyanate groups and one or more epoxide group(s) substantially inert to isocyanate groups, having an epoxide equivalent of 130 to 3000 g/eq and a molecular mass of 250 to 2500 dalton, being allowed to react with
   5 to 500 parts by weight of a polyisocyanate component (B), consisting of at least one diisocyanate, polyisocyanate, polyisocyanate derivative or polyisocyanate homologue having two or more (cyclo)aliphatic and/or aromatic isocyanate groups and a molecular mass of 100 to 2500 dalton, optionally in the presence of 0.01 to 0.5 part by weight of a catalyst component (K)(i) customary for polyaddition reactions with polyisocyanates, the mixture of the components (A)(i) and (B) being reacted either simultaneously or stepwise with the component (A)(ii), and optionally
   0 to 200 parts by weight of a low molecular weight polyol component (A)(iii) having one or more hydroxyl group(s) reactive towards isocyanate groups and a molecular weight of 50 to 500 dalton,
   0 to 500 parts by weight of a functionalized low molecular weight polyol component (A)(iv) having one or more hydroxyl group(s) reactive towards isocyanate groups and one or more carboxyl and/or phosphonate and/or sulfonate group(s) inert to isocyanate groups and/or polyalkylene oxide group(s) and/or perfluoroalkyl group(s) and having a molecular mass of 50 to 2500 dalton, and
   0 to 800 parts by weight of a higher molecular weight (polymeric) polyol component (A)(v) having one or more hydroxyl groups reactive towards isocyanate groups and a molecular mass of from 500 to 5000 dalton,
   0 to 600 parts by weight of a reactive diluent component (C), consisting of at least one (aqueous) epoxy resin having one or more epoxide group(s) substantially inert to isocyanate groups, an epoxide equivalent of 130 to 400 g/eq and a molecular mass of 50 to 1000 dalton, and
   0 to 50 parts by weight of a coalescence auxiliary component (D), 5 to 900 parts by weight of a formulation component (F)(i), consisting of reactive and/or inert fillers, pigments, carrier materials, nanomaterials, nanocomposites, other additives, plasticizers, solvents and water
   being added to the reaction mixture and
   a₂) optionally the prepolymer from stage a₁) being emulsified or dispersed in 0 to 900 parts by weight of water and optionally the formulation component (F)(i) being added,
and by
b) the preparation of a (latently) aminofunctional curing component (II),
10 to 900 parts by weight of a (polymeric) polyamine component (E), consisting of one or more (polymeric) polyamines having one or more (cyclo)aliphatic and/or aromatic primary and/or secondary amino group(s) reactive towards epoxide groups and optionally one or more hydroxyl group(s) and having a molecular mass of 60 to 5000 dalton, in the form of pure (polymeric) polyamines, polyaspartic acid esters, latent curing agents or reactive diluents based on aldimines and/or ketimines and/or enamines and/or oxazolidines, latent curing agents free of cleavage products and based on azetidines and/or diazepines and/or ammonium salts, commercially available liquid amine curing formulations or suitable combinations thereof,
10 to 900 parts by weight of a formulation component (F)(ii), consisting of reactive and/or inert fillers, pigments, carrier materials, nanomaterials, other additives, plasticizers, solvents and water, and
0.01 to 0.5 part by weight of an accelerator component (K)(ii) customary for polyaddition reactions with epoxy resins
being combined.

Surprisingly, it was found that, by using polyurethane-based two-component (aqueous) hybrid reactive resin systems with an epoxide/amine curing mechanism, not only are coating systems having substantially improved processing properties obtainable but these moreover have an improved property profile. In addition, it was not foreseeable that the viscosity of the epoxy-functional (aqueous) binder component would be very low. In contrast to the three- or four-component PCC coating system (UCrete®) known from the prior art and containing a binder component, an isocyanate component, a cement-containing powder component and optionally also a pigment component, only two components are required in the case of the system according to the invention, with the result that mixing errors in the application can be avoided. The formulation constituents (powder component) can be directly integrated in the binder component and/or in the curing component. Since, in comparison with the prior art, no isocyanate/water reaction occurs and hence no carbon dioxide formation occurs, the use of calcium oxide and/or calcium hydroxide in the formulation component can be dispensed with in comparison with the prior art. For avoiding VOC emissions, the curing component can also be immobilized within the formulation component.

As suitable functionalized low molecular weight polyol component (A)(i), it is possible to use, for example, glycidol, glyceryl diglycidyl ether, (cyclo)aliphatic and/or aromatic polyols partly etherified with epichlorohydrin, such as butane-1,4-diol, p-tert-butylphenol, 1,4-cyclohexanedimethanol, ethylene glycol, n-dodecanol, 2-ethylhexanol, glycerol and polyglycerol, hexane-1,6-diol, hydrogenated bisphenol A, hydrogenated bisphenol F, 2-methylpropane-1,3-diol, o-cresol, neopentylglycol, pentaerythritol, polyethylene glycols, polypropylene glycols, polyalkylene glycols, propane-1,2(3)-diol, n-tetradecanol, trimethylolpropane or hydroxyfunctional mono- and polyfunctional glycidyl ethers, epoxidized unsaturated fatty alcohols, reaction products of aliphatic and/or aromatic diepoxides and aliphatic and/or aromatic secondary monoamines, the reaction preferably being carried out in the molar ratio 1:1, reaction products of aliphatic and/or aromatic diepoxides and aliphatic and/or aromatic primary monoamines, the reaction preferably being carried out in the molar ratio 2:1, reaction products of aliphatic and/or aromatic diepoxides and (un)saturated fatty acids and/or fatty alcohols and/or fatty amines, the reaction preferably being carried out in the molar ratio 1:1, or suitable combinations thereof. Glycidol and/or glyceryl diglycidyl ether and/or (cyclo)aliphatic and/or aromatic polyols partly etherified with epichlorohydrin or hydroxyfunctional mono- and polyfunctional glycidyl ethers are preferably used.

As suitable functionalized higher molecular weight (polymeric) polyol component (A)(ii), it is possible to use, for example, epoxidized and (partly) ring-opened (un)saturated triglycerides, dimer fatty acid diols, oleochemical polyols, the commercial products Sovermol® 45, 100, 320, 650 NS, 750, 760, 805, 810, 815, 818, 819, 820, 850, 860, 908, 912 Pearls, 920, 1005, 1012, 1014, 1052, 1055, 1058, 1059, 1066, 1068, 1080, 1083, 1090, 1095, 1102, 1106, 1111, 9155 and Speziol® C 10-2, C 18-2, C 36-2 from Cognis Deutschland GmbH & Co. KG, hydroxyfunctional epoxy resins or epoxy resin derivatives or suitable combinations thereof. (Un)saturated triglycerides which are epoxidized and (partly) ring-opened with alcohols are preferably used.

As suitable low molecular weight polyol component (A)(iii), it is possible to use, for example, 1,4-butanediol, 2-methyl-1,3-propanediol, 2,2-dimethyl-1,3-propanediol, 1,2-dihydroxyalkanediols having 5-50 carbon atoms of the general formula (I)

CₙH₂ₙ₊₁—CHOH—CH₂O (I)

where n=3 to 48,

reaction products of alkylene 1-oxides of the general formula (II)

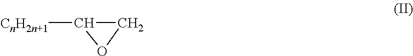

where n=3 to 48

with N-methylethanolamine or ethanolamine or diethanolamine or other compounds having a primary or secondary amino group and one or more hydroxyl group(s),

α,ω-dihydroxyalkanediols having 5 to 50 carbon atoms of the general formula (III)

HO—CₙH₂ₙ—OH (III)

where n=3 to 50

or suitable combinations thereof.

As suitable functionalized low molecular weight polyol component (A)(iv), it is possible to use, for example,
(i) bishydroxyalkanecarboxylic acids, such as dimethylolpropionic acid, and/or
(ii) dihydroxyfunctional reaction products of monofunctional alkyl/cycloalkyl/arylpolyalkylene glycols, diisocyanates and dialkanolamines and/or
(iii) amino- and/or hydroxy- and/or mercaptofunctional fluoromodified macro-monomers or telechelic structures having a polymer-bound fluorine content of 1 to 99% by weight and a molecular mass of 100 to 10 000 dalton, containing, arranged intrachenally in the main chain and/or side chain and/or laterally and/or terminally, the structural elements of the general formula (IV)

—(CF₂—CF₂)ₙ— (IV)
where n≧3
and/or of the general formula (V)

—(CF₂—CFR—O)ₙ— (V)

where n≧3 and R═F, CF₃,

having in each case one or more (cyclo)aliphatic and/or aromatic primary and/or secondary amino group(s) and/or hydroxyl group(s) and/or mercapto group(s), preferably dihydroxyfunctional reaction products of perfluoroalkyl alcohols, diisocyanates and dialkanolamines, or suitable combinations thereof.

As suitable higher molecular weight (polymeric) polyol component (A)(v), it was possible to use, for example, (hydrophobically modified) polyalkylene glycols, (un)saturated aliphatic and/or aromatic polyesters, polycaprolactones, polycarbonates, α,ω-polybutadienepolyols, α,ω-polymethacrylatediols, α,ω-polysulphidediols, α,ω-dihydroxyalkylpolydimethylsiloxanes, hydroxyfunctional epoxy resins, hydroxyfunctional ketone resins, alkyd resins, dimer fatty acid dialcohols, reaction products based on bisepoxides and (un)saturated fatty acids, further hydroxyfunctional macromonomers and telechelic structures, mono- and/or di- and/or triesters of glycerol and saturated and/or unsaturated and optionally hydroxyfunctional fatty acids having 1 to 30 carbon atoms and having a functionality of f_{OH}≧2 or suitable combinations, such as blends or hybrid polymers thereof, or suitable combinations thereof.

As suitable polyisocyanate component (B), it is possible to use, for example, polyisocyanates, polyisocyanate derivatives or polyisocyanate homologues having two or more aliphatic and/or aromatic isocyanate groups of identical or different reactivity or suitable combinations thereof. In particular, the polyisocyanates sufficiently well known in polyurethane chemistry or combinations thereof are suitable. As suitable aliphatic polyisocyanates, it is possible to use, for example, 1,6-diisocyanatohexane (HDI), 1-isocyanato-5-isocyanatomethyl-3,3,5-trimethylcyclohexane or isophorone diisocyanate (IPDI, commercial product VESTANAT® IPDI from Degussa AG), bis(4-isocyanato-cyclohexyl)methane (H₁₂MDI, commercial product VESTANAT® H12MDI from Degussa AG), 1,3-bis(1-isocyanato-1-methylethyl)benzene (m-TMXDI), 2,2,4-trimethyl-1,6-diisocyanatohexane or 2,4,4-trimethyl-1,6-diisocyanatohexane (TMDI, commercial product VESTANAT® TMDI from Degussa AG) or industrial isomer mixtures of the individual aliphatic polyisocyanates or suitable combinations thereof. As suitable aromatic polyisocyanates, it is possible to use, for example, 2,4-diisocyanatotoluene or toluene diisocyanate (TDI), bis(4-isocyanatophenyl)methane (MDI) and optionally higher homologues thereof (polymeric MDI) or industrial isomer mixtures of the individual aromatic polyisocyanates or suitable combinations thereof. Furthermore, the so-called “coating polyisocyanates” based on bis(4-isocyanatocyclohexyl)methane (H₁₂MDI), 1,6-diisocyanatohexane (HDI), 1-isocyanato-5-isocyanatomethyl-3,3,5-trimethylcyclohexane (IPDI) or suitable combinations thereof are in principle also suitable. The term “coating polyisocyanates” designates those derivatives of these diisocyanates which have allophanate, biuret, carbodiimide, isocyanurate, oxadiazinetrione, uretdione or urethane groups and in which the residual content of monomeric diisocyanates was reduced to a minimum in accordance with the prior art. In addition, it is also possible to use modified polyisocyanates which are obtainable, for example, by hydrophilic modification of “coating polyisocyanates” with monohydroxyfunctional polyethylene glycols or aminosulphonic acids. For example, the commercial products VESTANAT® T 1890 E, VESTANAT® T 1890 L, VESTANAT® T 1890 M, VESTANAT® T 1890 SV, VESTANAT® T 1890/100 (polyisocyanates based on IPDI trimer), VESTANAT® HB 2640 MX, VESTANAT® HB 2640/100, VESTANAT® HB 2640/LV (polyisocyanates based on HDI biuret), VESTANAT® HT 2500 L, VESTANAT® HB 2500/100, VESTANAT® HB 2500/LV (polyisocyanates based on HDI isocyanurate) from Degussa AG or suitable combinations thereof can be used as suitable “coating polyisocyanates”. Bis(4-isocyanatophenyl)methane (MDI) and higher homologues thereof (polymeric MDI) and derivatives and/or 2,4-toluene diisocyanate and/or 2,6-toluene diisocyanate and/or isophorone diisocyanate or industrial isomer mixtures of the individual aliphatic and/or aromatic polyisocyanates and/or (hydrophilically modified) “coating polyisocyanates” having allophanate, biuret, carbodiimide, isocyanurate, oxadiazinetrione, uretdione or urethane groups and based on bis(4-isocyanatocyclohexyl)methane (H₁₂MDI), 1,6-diisocyanatohexane (HDI), 1-isocyanato-5-isocyanatomethyl-3,3,5-trimethylcyclohexane (IPDI) are preferably used.

As suitable reactive diluent component (C), it is possible to use, for example, (cyclo)aliphatic and/or aromatic polyols completely etherified with epichlorohydrin, such as butane-1,4-diol, p-tert-butylphenol, 1,4-cyclohexanedimethanol, ethylene glycol, n-dodecanol, 2-ethylhexanol, glycerol and polyglycerol, hexane-1,6-diol, hydrogenated bisphenol-A, hydrogenated bisphenol-F, 2-methylpropane-1,3-diol, o-cresol, neopentyl glycol, pentaerythritol, polyethylene glycols, polypropylene glycols, polyalkylene glycols, propane-1,2(3)-diols, n-tetradecanol, trimethylolpropane or mono- and polyfunctional glycidyl ethers, bisphenol-A diglycidyl ether and higher homologues thereof, bisphenol-F diglycidyl ether and higher homologues thereof, phenol novolak resins, epoxy resin dispersions, the commercial products Polypox® E 064, E 150, E 152, E 221, E 227, E 237, E 253, E 254, E 260, E 270, E 270/700, E 270/500, E 280, E 280/700, E 280/500, E 375, E 395, E 403, E 411, E 442, E 492, E 630 (epoxy resin (solvent-free)), E 2400/75, E 2401.80, E 1001×75 (epoxy resins (solvent-containing)), E 260 W, E 2500/60 W (epoxy resins (for aqueous systems)), R 3, R 6, R 7, R 9, R 11, R 12, R 14, R 16, R 17, R 18, R 19, R 20, R 24 (glycidyl ether) from UPPC AG or suitable combinations thereof, industrial products also containing (cyclo)aliphatic and/or aromatic polyols partly etherified with epichlorohydrin, according to (A)(i). (Cyclo)aliphatic and/or aromatic polyols completely etherified with epichlorohydrin or hydroxyfunctional mono- and polyfunctional glycidyl ethers are preferably used. For example, alcohols, such as, for example, benzyl alcohol, or a suitable combination thereof can be used as suitable extenders.

As suitable coalescence auxiliary component (D), it is possible to use, for example, low-boiling, aprotic solvents, such as acetone or propanone, butanone, 4-methyl-2-pentanone, ethyl acetate, n-butyl acetate, or high-boiling aprotic solvents, such as N-methyl-2-pyrrolidone, N-ethyl-2-pyrrolidone, diethylene glycol dimethyl ether, dipropylene glycol dimethyl ether, ethylene glycol monoalkyl ether acetates, diethylene glycol monoalkyl ether acetates, dialkyl adipates, cyclic alkylene carbonates or suitable combinations thereof. High-boiling solvents, such as N-ethylpyrrolidone, and/or N-methylpyrrolidone and/or dipropylene glycol dimethyl ether and/or dialkyl adipates and/or cyclic alkylene carbonates are preferably used.

As suitable (polymeric) polyamine component (E) it is possible to use, for example, polyamines having two or more aliphatic and/or aromatic, primary and/or secondary amino groups of identical or different reactivity or suitable combinations thereof. As suitable aliphatic polyamines, it is possible to use, for example, 1,3-pentanediamine (DAMP), 2-methylpentamethylenediamine (MPMDA), benzylaminopropylamine (BAPA), bisaminomethylcyclohexane or 1,3-bis(aminomethyl)cyclohexane (1,3-BAC), cyclohexylaminopropylamine (NAPCHA), diaminocyclohexane or 1,2-diaminocyclohexane (DAC or DCH), diethylaminopropylamine (DEAPA), diethylenetriamine or 1,4,7-triazaheptane (DETA), dimethyl-PACM or bis(4,4′-amino-3,3′-methylcyclohexyl)methane (DM-PACM), dipropylenetriamine or 1,5,9-triazanonane, ethylenediamine or 1,2-diaminoethane (EDA), hexamethylenediamine or 1,8-diazaoctane (HMDA), isophoronediamine or 3-methylamino-3,5,5-trimethylaminocyclohexane (IPD or IPDA), methylpentamethylenediamine or 2-methyl-1,7-diazaheptane, N3-amine or 1,4,8-triazaoctane, N4-amine or 1,5,8,12-tetraazadodecane, N-aminoethylpiperazine or 1-(2-aminoethyl)-1,4-diazacyclohexane (NAEP), N-aminopropylcyclohexylamine (NAPCHA), p-aminocyclohexylmethane or bis(4,4′-aminocyclohexyl)methane (PACM), pentaethylenehexamine or 1,4,7,10,13,16-hexaazahexadecane (PEHA), propylenediamine or 1,5-diazapentane (PDA), tetraethylenepentamine or 1,4,7,10,13-pentaazatridecane (TEPA), tricyclododecanediamine or 3(4),8(9)-bis(aminomethyl)tricyclo-[5,2,1,0^{2,6}]decane (TCD), triethylenetetramine or 1,4,7,10-tetraazadecane (TETA), trimethylhexamethylenediamine or 2,2,4-trimethyl-1,8-diazaoctane and/or 2,4,4-trimethyl-1,8-diazaoctane or suitable combinations thereof. As suitable aromatic polyamines, it is possible to use, for example, diaminodiphenylmethane or bis(4,4′-aminophenyl)methane (DDM), diaminodiphenyl sulphone or bis(4,4′-aminophenyl)sulphone (DDS), diethylaminodiphenylmethane (DEDDM), diethyltoluenediamine (DETDA), m-xylylenediamine or 1,3-bis(aminomethyl)benzene (mXDA) or suitable combinations thereof. As suitable aromatic polyoxyalkyleneamines, it is possible to use, for example, polyoxyethylenepolyamines, polyoxypropylenepolyamines, polytetrahydrofuranpolyamines, other polyoxyalkylenepolyamines based on any desired alkylene oxide or mixtures thereof (co, block, random), butanediol ether diamine or 1,14-diaza-5,10-dioxotetradecane (BDA) or suitable combinations thereof. In addition, polyaminoamides, Mannich bases, epoxide adducts, such as EDA adduct, DETA adduct, type 100, type 115, type 125, type 140, type 250 (genamide), PAA adduct, the commercial products Polypox® IH 7001, IH 7002, IH 7003, IH 7004, H 013, H 014, H 015, H 016, H 030, H 038, H 043, H 043 S, H 043 L, H 051, H 060, H 100, H 129, H 147, H 160, H 205, H 206, H 229, H 244, H 262, H 269, H 276/90, H 300, H 300 S, H 300 SL, H 310, H 333, H 354, H 354 L, H 415, H 445, H 445 L, H 480, H 483, H 488, H 488 L, H 489, H 490, H 497, H 501, H 503, H 610, H 611 (epoxy resin curing agents (polyamines)), IH 7005W, IH 7006W, W 800, W 802, W 804, W 810, W 860 (epoxy resin curing agents (aqueous)), P 215×70, P 225, P 240, P 245, P 250, P 350, P 370, P 450, P 450 S, P 499, P 502 (epoxy resin curing agents (polyaminoamides/polyaminoimidazolidines)) from UPPC AG or suitable combinations thereof can be used. Ethylenediamine and/or liquid epoxy resin curing agents formulated ready for use and based on aliphatic and/or aromatic polyamines and/or polyamidoamines are preferably used.

The component (E) may be present in coated and/or microencapsulated and/or carrier-fixed and/or hydrophilized and/or solvent-containing form and optionally may have sustained-release properties.

As suitable formulation components (F)(i) and (F)(ii), it is possible to use, for example, reactive inorganic fillers selected from the group consisting of cement, calcium oxide, calcium hydroxide or calcium sulphate or suitable combinations thereof.

As suitable formulation components (F)(i) and (F)(ii), it was also possible to use, for example, (functionalized) inorganic and/or organic fillers and/or light fillers inert to water, (functionalized) inorganic and/or organic pigments, (functionalized) inorganic and/or organic carrier materials, (functionalized) inorganic and/or organic nanomaterials, (functionalized) inorganic and/or organic nanocomposites, inorganic and/or organic fibres, graphite, carbon black, carbon fibres, carbon nanotubes, metal fibres and metal powders, conductive organic polymers, redispersible polymer powders or superabsorbers and suitable combinations thereof.

As suitable formulation components (F)(i) or (F)(ii), it is also possible to use, for example, other additives selected from the group consisting of antifoaming agents, deaerators, lubricating and leveling additives, substrate wetting additives, wetting and dispersing additives, water repellents, rheology additives, coalescence auxiliaries, dulling agents, adhesion promoters, antifreezes, antioxidants, UV stabilizers, biocides and suitable combinations thereof.

As suitable formulation components (F)(i) or (F)(ii), it was furthermore possible to use, for example, plasticizers selected from the group consisting of dialkyl phthalate, dialkyl adipate, biodiesel, rapeseed oil methyl ester, fatty acid derivatives, triglyceride derivatives or suitable combinations thereof.

As suitable catalyst component (K)(i), it was possible to use, for example, dibutyltin oxide, dibutyltin dilaurate (DBTL), triethylamine, tin(II) octanoate, 1,4-diazabicyclo[2,2,2]octane (DABCO), 1,4-diazabicyclo[3,2,0]-5-nonene (DBN), 1,5-diazabicyclo[5,4,0]-7-undecene (DBU), morpholine derivatives, such as, for example, JEFFCAT® amine catalysts or suitable combinations thereof.

As suitable accelerator component (K)(ii), it was possible to use, for example, benzyldimethylamine, 4-N,N-dimethylaminophenol, 2,4,6-tris(N,N-dimethylaminomethyl)phenol, 2-methylimidazole, 2-phenylimidazole, other suitable tertiary amines or suitable combinations thereof.

The present invention furthermore relates to a process for the preparation of the two-component (aqueous) hybrid reactive resin system according to the invention, characterized in that
a) an epoxyfunctional (aqueous) binder component (I) is prepared by
   a₁) allowing the components (A)(i), (A)(ii) and (B) to react, optionally in the presence of the component (K)(i), the mixture of the components (A)(i) and (B) being reacted either simultaneously or stepwise with the component (A)(ii), and optionally the components (A)(iii), (A)(iv), (A)(v), (C) and (D) also being added to the reaction mixture, and
   a₂) optionally the prepolymer from stage a₁) being emulsified or dispersed in water and optionally the formulation component (F)(i) being added, and
b) preparing a (latently) aminofunctional curing component (II) by combining the components (E), (F)(ii) and (K)(ii) in any desired sequence.

The stage a₁) is carried out with avoidance of epoxide/isocyanate secondary reactions (e.g. cycloaddition with formation of cyclic urethanes).

The metering of the components (A), (B), (C), (D), (F)(i), (K)(i) used in the stages a) and b) can be effected in any desired manner.

The NCO/OM equivalent ratio of the components (A) and (B) in stage a) is preferably adjusted to 1.2 to 2.5, in particular to 1.3 to 2.0.

The stage a₁) is carried out at a preferred temperature of 40 to 90° C., in particular at 65 to 85° C.

The stage a₂) is carried out at a preferred temperature of 30 to 60° C., in particular at 40 to 50° C.

The stage b) is carried out at a preferred temperature of 10 to 40° C., in particular at 20 to 30° C.

According to a preferred embodiment, an epoxyfunctional binder component (I) which is self-emulsifying even without additional anionic and/or nonionic hydrophilization is used in stage a).

The solids content of the epoxyfunctional aqueous binder component (I) consisting of the components (A), (B) and (C) in stage a) is preferably adjusted to 10 to 100% by weight, in particular to 25 to 75% by weight.

The solids content of the two-component coating system consisting of the components (I) and (II) is preferably adjusted to 10 to 100% by weight, in particular to 25 to 75% by weight.

The present invention furthermore relates to the use of the two-component (aqueous) hybrid reactive resin system according to the invention for the production of coating systems which are resistant to chemicals, heat-resistant and abrasion-resistant, have a high mechanical load-bearing capacity and are easy to clean, for mineral and nonmineral surfaces based on concrete, cement, lime, gypsum, anhydrite, geopolymers, glass, wood and wood-based materials, composite materials, artificial and natural stone, plastic and glass fibre-reinforced plastic (GRP), metal and polymers.

The two-component (aqueous) hybrid reactive resin system according to the invention is suitable in the construction sector and industrial sector for the production of coating systems which are resistant to chemicals, heat-resistant, and abrasion-resistant, have a high mechanical load-bearing capacity and are easy to clean, for the applications
antigraffiti coatings
antisoiling coatings
seals
antislip coverings
dischargeable floor coating systems (ESD/AS)
balcony coatings
easy-to-clean coatings
leveling and priming of concrete
fresh concrete coatings
floor coatings
garage coatings
water protection coating systems according to §19 WHG
high-bay warehouse coatings according to DIN 15185
parking floor coatings
PCC coating systems
pipeline coatings
crack-bridging coating systems
hopper coatings
sport floor covering systems
wall coatings.

The two-component (aqueous) hybrid reactive resin system according to the invention is suitable in the construction sector and industrial sector for the production of coating systems which are resistant to chemicals, heat-resistant and abrasion-resistant, have a high mechanical load-bearing capacity and are easy to clean, for the following fields of use
wastewater treatment
chemical industry
printing industry
disposal
beverage industry
commercial kitchens and restaurants
hygiene applications
cold halls and cold stores
storage halls and warehouses
agricultural
food industry
paper industry
pharmaceutical industry
pipelines
private households
refineries
clean-room areas (e.g. chip and wafer production)

The two-component (aqueous) hybrid reactive resin system according to the invention is suitable in the construction sector and industrial sector for the production of coating systems which are resistant to chemicals, heat-resistant and abrasion-resistant, have a high mechanical load-bearing capacity and are easy to clean and optionally consist of a primer and at least one primer coat which is not lightfast and is optionally sanded and optionally of a topcoat which is lightfast and optionally fluoromodified and optionally sanded.

The two-component (aqueous) hybrid reactive resin system according to the invention can be used in any desired combination with conventional three-component PCC coating systems (UCrete®) and/or aqueous and/or reactive polyurethane coating systems and/or aqueous and/or reactive epoxy resin coating systems in the applications
repair
retopping
mixed system structure.

The two-component (aqueous) hybrid reactive resin system according to the invention can be used in the applications
job-mix concrete
concrete products (precast concrete parts, concrete ware, cast stones)
poured-in-place concrete
air-placed concrete
ready-mixed concrete.

The epoxyfunctional (aqueous) binder component (I) and the (latently) amino-functional curing component (II) are mixed in the preferred epoxide/amino equivalent ratio of 0.8 to 1.2, in particular 0.9 to 1.1, to give a two-component coating system.

The coating system is preferably applied in coats having a total thickness of 0.1 to 50 mm to elastic or rigid substrates, it being used in particular in an amount of 0.1 to 10.0 kg per m² of the area to be coated and per operation.

The coating system can be applied here horizontally and vertically and without a primer (and without bubble formation) to (moist) fresh concrete.

The hybrid reactive resin system according to the invention can be used in particular for crack-bridging and cavity-filling coatings.

The application of the coating system is effected by the methods known from painting and coating technology, such as, for example, flooding, pouring, application with a doctor blade, roller-coating with a soft roller, spraying, brushing, immersion or roller-coating with a hard roller.

The following examples are intended to illustrate the invention in more detail.

### EXAMPLES

### Example 1

Synthesis of an Epoxyfunctional Hybrid Resin (1)

In a 250 ml three-necked round-bottomed flask with a KPG stirrer, internal thermometer and air condenser, a mixture of 45.00 g of IPDI (Degussa AG) and 14.62 g of glycidol was cooled to 17° C. and DBTL was added as a catalyst. Thereafter, the reaction mixture was stirred at a temperature of 60° C. until the theoretical NCO value of 14.23% by weight was reached. After addition of 45.21 g of Sovermol 818 (Cognis GmbH), stirring was effected for a further 4 h at 80° C. until complete conversion of the NCO groups, and a resin viscosity of about 140 000 mPa·s was established by dilution with 34.99 g of Polypox R 18 (UPPC AG).

The product obtained was a homogeneous, slightly yellow resin having an epoxide value of 3.03 mol/kg.

For curing of the reactive resin, 8.19 g of the curing agent Polypox VH 01198/10 (UPPC AG) were added to 45.00 g of (1) and homogenization was effected. After a potlife of about 40 min, a Shore D hardness of about 71 resulted.

### Example 2

Synthesis of an Epoxyfunctional Hybrid Resin (2)

In a 500 ml three necked round-bottomed flask with a KPG stirrer, internal thermometer and air condenser, a mixture of 134.99 g of Polypox R 18 (UPPC AG), 22.14 g of glycidol and 108.00 g of IPDI (Degussa AG) was heated to a temperature of 33° C. with stirring and 0.15 g of DBTL was added as a catalyst. After the very strongly exothermic reaction had died down, the reaction mixture was stirred for a further 30 min at 80° C. until a theoretical NCO value of 7.70% by weight had been reached. After addition of 108.51 g of Sovermol 818 (Cognis GmbH), stirring was effected for a further 4 h at 60° C. for complete conversion of all NCO groups and a total proportion of reactive diluent of 45% by weight was established by dilution with 60.42 g of Polypox R 18 (UPPC AG).

The product obtained was a homogeneous, slightly yellow resin having an epoxide value of 276.73 g/eq.

For curing of the reactive resin, 3.79 g of the curing agent Polypox H 503 (UPPC AG) were added to 30.00 g of (2) and homogenization was effected. After curing for 48 h at 50° C., a casting having a Shore D hardness of 74 was obtained.

### Example 3

Synthesis of an Epoxyfunctional Hybrid Resin (3)

In a 250 ml three-necked round-bottomed flask with a KPG stirrer, internal thermometer and air condenser, a mixture of 45.00 g of IPDI (Degussa AG) and 14.62 g of glycidol was initially introduced and 0.15 g of DBTL was added as a catalyst while cooling with a waterbath. After the exothermic reaction had died down, the reaction mixture was stirred for a further 60 min at 60° C. until the theoretical NCO value of 14.23% by weight was reached. After addition of 43.92 g of Desmophen VP LS 2328 (Bayer MaterialScience AG), stirring was effected for a further 3 h at 80° C. for complete conversion of the NCO groups and, after dilution with 34.56 g of Polypox R 18 (UPPC AG), a reactive resin having a viscosity of 91 000 mPa·s and an epoxide value of 327.60 g/eq was obtained.

For curing of the resin, 8.24 g of the curing agent Polypox VH 01198/10 (UPPC AG) were added to 45.00 g of (3) and homogenization was effected. After a potlife of 45 min, a casting having a Shore D hardness of 67 was obtained.

### Example 4

Synthesis of an Epoxyfunctional Hybrid Resin (4)

In a 250 ml three-necked round-bottomed flask with a KPG stirrer, internal thermometer and air condenser, a mixture of 45.00 g of IPDI (Degussa AG) and 15.00 g of glycidol was initially introduced and 0.15 g of DBTL was added as a catalyst while cooling with a waterbath. After the exothermic reaction had died down, the reaction mixture was stirred for a further 30 min at 80° C. until the theoretical NCO value of 14.14% by weight was reached. After addition of 99.01 g of Oxyester T 1136 (Degussa AG), stirring was effected for a further 3.5 h at 80° C. for complete conversion of the NCO groups and a total proportion of reactive diluent of 25% by weight was established by dilution with 53.05 g of Polypox R 18 (UPPC AG).

The product obtained was a homogeneous, slightly yellow resin having an epoxide value of 390.69 g/eq.

For curing of the resin, 6.91 g of the curing agent Polypox VH 01198/10 (UPPC AG) were added to 45.00 g of (3) and homogenization was effected. After a potlife of about 90 min, a casting having a Shore D hardness of 26 was obtained.

### Example 5

Synthesis of an Epoxyfunctional Hybrid Resin (5)

In a 500 ml three-necked round-bottomed flask with a KPG stirrer, internal thermometer and air condenser, a mixture of 150.83 g of Polypox R 18 (UPPC AG), 24.60 g of glycidol and 120.00 g of IPDI was initially introduced and, after heating to 38° C., 0.15 g of DBTL was added as a catalyst. After the exothermic reaction had died down, stirring was effected for about 30 min at 80° C. until a theoretical NCO value of 7.67% by weight was reached. After addition of 264.03 g of Oxyester T 1136 (Degussa AG), stirring was effected for a further 6 h at 80° C. for complete conversion of the NCO groups.

The product obtained was a homogeneous, slightly yellow resin having an epoxide value of 426.37 g/eq and a viscosity of 50 000 mPa·s. The total proportion of reactive diluent is 26.95% by weight.

For curing of the resin, 2.46 g of the curing agent Polypox H 503 (UPPC AG) were added to 30.00 g of (3) and homogenization was effected. After curing for 24 h at 70° C., a casting having a Shore D hardness of 36 was obtained.

Mechanical Properties of Various Reactive Resins

| | Reactive | | | Elongation | Tensile |
|---|---|---|---|---|---|
| Reactive | diluent | Viscosity | | at break | strength |
| resin | [% by wt.] | [mPa · s] | Shore D** | [%]** | [MPa]** |
| (2)* | 45 | 8800 | 67-74 | 34-38 | 20-23 |
| (6)* | 50 | 4000 | 66 | 35-49 | 15-20 |
| (7)* | 55 | 2500 | 60 | 45-57 | 15-22 |
| (8)* | 60 | 1200 | 52-57 | 48-55 | 16-24 |
| (9)* | 65 | 670 | 41 | 45-52 | 11-16 |

*The syntheses of the reactive resins (6)-(9) take place analogously to the synthesis of resin (2) but with an increased proportion of reactive diluent
**Polypox H503 was used for curing all resins.

### Example 6

Guide Recipe for the Formulation of Epoxyfunctional Hybrid Reactive Resins

| | | | Weight taken |
|---|---|---|---|
| No. | Formulation constituents | % by weight | (g) |
| 1 | Reactive resin component | 10.00 | 8.00 |
| | (cf. Examples 1-5) | | |
| 2 | SR-POX 2500 | 37.00 | 29.60 |
| | (Maeder GmbH) | | |
| 3 | PERENOL E5 | 1.00 | 0.80 |
| | (Cognis GmbH) | | |
| 4 | TEXAPHOR P63 | 1.00 | 0.80 |
| | (Cognis GmbH) | | |
| 5 | PHOTOMER 4094 | 7.50 | 6.00 |
| | (Cognis GmbH) | | |
| 6 | TALKUM AT1 | 5.00 | 4.00 |
| 7 | ALBAWHITE 60 | 27.00 | 21.60 |
| 8 | RILANIT SPEZIAL MICRO W | 1.50 | 1.20 |
| 9 | HEUCOSIN-SPEZ. Light grey | 10.00 | 8.00 |
| | G 1039 | | |
| | | 100.00 | 80.00 |

No. 1-5 were initially introduced into a mixing beaker and homogenized. No. 6-9 were then weighed into a further beaker and added to the mixture of 1-5. The total mixture thus obtained was dispersed in a Speedmixer until a temperature of 50° C. was reached (temperature monitoring). For deaeration, the paint thus obtained was allowed to stand overnight.

For curing, 5.84 g of the curing agent Polypox H 503 (UPPC AG) or 10.01 g of the curing agent Polypox VH 01198/10 (UPPC AG) were added in each case to 80.00 g of the formulated binder (epoxide content: 2.09 mol/kg) and homogenization was effected. After a potlife of about 3 h (Polypox H 503) or 1.5 h (Polypox VH 01198/10), Shore D hardnesses of 70-75 were obtained in each case.

1-38. (canceled)

39. A two-component, aqueous hybrid reactive resin system prepared by the process of:
a) preparing an epoxyfunctional aqueous binder component (I) having an epoxide equivalent of 100 to 12,500 g/eq, an average molecular mass of 200 to 25,000 dalton and a viscosity of 1,000 to 150,000 mPa·s as measured at 20° C. with a Brookfield viscometer;
a₁) 5 to 300 parts by weight of a functionalized low molecular weight polyol component (A)(i), comprising at least one of an hydroxyfunctional epoxy-alcohol, a glycidyl ether having at last one hydroxyl group that reacts with an isocyanate group and one or more epoxide group substantially inert to isocyanate groups, having an epoxide equivalent of 100 to 500 g/eq and a molecular mass of 50 to 1,000 dalton; with
0 to 300 parts by weight of a functionalized higher molecular weight polymeric polyol component (A)(ii) having at least one hydroxyl group reactive with an isocyanate group and one or more epoxide group substantially inert to an isocyanate group, having an epoxide equivalent of 130 to 3,000 g/eq and a molecular mass of 250 to 2,500 dalton;
and reacting with
5 to 500 parts by weight of a polyisocyanate component (B) comprising at least one diisocyanate, polyisocyanate, polyisocyanate derivative or polyisocyanate homologue having two or more (cyclo)aliphatic or aromatic isocyanate groups and a molecular mass of 100 to 2,500 dalton, optionally in the presence of 0.01 to 0.5 part by weight of a catalyst component (K)(i) suitable for polyaddition a reaction with a polyisocyanate, wherein the mixture of the components (A)(i) and (B) are reacted either simultaneously or stepwise with the component (A)(ii), and optionally
0 to 200 parts by weight of a low molecular weight polyol component (A)(iii) having at least one hydroxyl group reactive towards an isocyanate group and a molecular weight of 50 to 500 dalton;
0 to 500 parts by weight of a functionalized low molecular weight polyol component (A)(iv) having at least one hydroxyl group reactive with an isocyanate group and one or more carboxyl, phosphonate, or sulfonate groups inert to an isocyanate group or polyalkylene oxide, or perfluoroalkyl group and having a molecular mass of 50 to 2500 dalton, and
0 to 800 parts by weight of a higher molecular weight polymeric polyol component (A)(v) having at least one hydroxyl groups reactive with an isocyanate group and a molecular mass of from 500 to 5,000 dalton,
0 to 600 parts by weight of a reactive diluent component (C), comprising at least one aqueous epoxy resin having at least one epoxide group substantially inert to an isocyanate group, an epoxide equivalent of 130 to 400 g/eq and a molecular mass of 50 to 1,000 dalton, and
0 to 50 parts by weight of a coalescence auxiliary component (D), or
5 to 900 parts by weight of a formulation component (F)(i), comprising a reactive filler, an inert filler, a pigment, a carrier material, a nanomaterial, a nanocomposite, a plasticizer, a solvent and water to form a prepolymer;
a₂) optionally emulsifying or dispersing the prepolymer from stage a₁) in 0 to 900 parts by weight of water and optionally adding formulation component (F)(i) being added, and
b) preparing a latently aminofunctional curing component (II) by combining;
10 to 900 parts by weight of a polymeric polyamine component (E), comprising one or more polymeric polyamines having one or more (cyclo)aliphatic, aromatic primary or secondary amino group reactive with an epoxide group and optionally at least one hydroxyl group and having a molecular mass of 60 to 5000 dalton, in the form of a pure polymeric polyamine, polyaspartic acid ester, a latent curing agent or a reactive diluent based on an aldimine, a ketimine, an enamine, or an oxazolidine, a latent curing agent free of cleavage products and based on an azetidine, a diazepine, or an ammonium salt, a liquid amine curing formulation or a combinations thereof,
10 to 900 parts by weight of a formulation component (F)(ii), comprising a reactive or an inert filler, pigment, a carrier material, a nanomaterial, an other additive, a plasticizer, a solvent and water, and
0.01 to 0.5 part by weight of an accelerator component (K)(ii) for a polyaddition reaction with an epoxy resin
are combined.

40. The hybrid reactive resin system according to claim 39, wherein the component (A)(i) comprises at least one of a glycidol or glyceryl diglycidyl ether, or a (cyclo)aliphatic or aromatic polyol partly etherified with at least one of epichlorohydrin or a mono- or polyfunctional glycidyl ether.

41. The hybrid reactive resin system of claim 39, wherein the component (A)(ii) comprises an (un)saturated triglyceride epoxidized and partly ring-opened with an alcohol.

42. The hybrid reactive resin system of claim 39, wherein the component (A)(iii) comprises at least one of 1,4-butanediol, 2-methyl-1,3-propanediol, 2,2-dimethyl-1,3-propanediol or a 1,2-dihydroxyalkanediol having 5 to 50 carbon atoms of the general formula (I)
CₙH₂ₙ₊₁—CHOH—CH₂OH (I)
where n is from 3 to 48
or a reaction product of alkylene 1-oxides of the general formula (II) 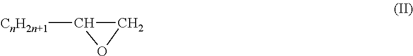
wherein n is from 3 to 48
with N-methylethanolamine or ethanolamine or diethanolamine or an other compound having a primary or secondary amino group and one or more hydroxyl group
or α,ω-dihydroxyalkanediols having 5 to 50 carbon atoms of the general formula (III)
HO—CₙH₂ₙ—OH (III)
wherein n is from 3 to 50.

43. The hybrid reactive resin system of claim 39, wherein the component (A)(iv) comprises
(i) a bishydroxyalkanecarboxylic acid, or
(ii) a dihydroxyfunctional reaction product of a monofunctional alkyl/cycloalkyl/arylpolyalkylene glycol, a diisocyanate and a dialkanolamine or
(iii) an amino- or hydroxy-, or mercaptofunctional fluoromodified macromonomer or telechelic structure having a polymer-bound fluorine content of 1 to 99% by weight and a molecular mass of 100 to 10,000 dalton, containing, arranged intrachenally in the main chain, side chain or laterally, or terminally, the structural element of formula (IV)
—(CF₂—CF₂)ₙ— (IV)
wherein n≧3;
or of formula V
—(CF₂—CFR—O)ₙ— (V)
wherein n≧3 and R is F or CF₃,
having in each case one or more (cyclo)aliphatic, or aromatic primary or secondary amino group, a hydroxyl group or a mercapto group.

44. The hybrid reactive resin system of claim 39, wherein the component (A)(iv) comprises a dihydroxyfunctional reaction product of perfluoroalkyl alcohol, diisocyanate and dialkanolamine.

45. The hybrid reactive resin system of claim 39, wherein the component (A)(v) comprises a hydrophobically modified polyalkylene glycol, an (un)saturated aliphatic or aromatic polyester, a polycaprolactone, a polycarbonate, an α,ω-polybutadienepolyol, an α,ω-polymethacrylatediol, an α,ω-polysulphidediol, an α,ω-dihydroxyalkylpolydimethylsiloxane, an hydroxyfunctional epoxy resin, an hydroxyfunctional ketone resin, an alkyd resin, a dimer fatty acid dialcohol, a reaction product based on a bisepoxide and an (un)saturated fatty acid, a further hydroxyfunctional macromonomer and telechelic structure, a mono-, di-, or triester of glycerol and saturated or unsaturated and optionally hydroxyfunctional fatty acid having 1 to 30 carbon atoms and having a functionality of f_{OH}≧2 or a suitable combination thereof.

46. The hybrid reactive resin system of claim 39, wherein the component (B) comprises bis(4-isocyanato-phenyl)methane are higher homologue thereof, and a derivative or 2,4-toluene diisocyanate, or 2,6-toluene diisocyanate or isophorone diisocyanate or an isomer mixture of the individual aliphatic or aromatic polyisocyanates or a hydrophilically modified coating polyisocyanates having an allophanate, biuret, carbodiimide, isocyanurate, oxadiazinetrione, uretdione or urethane group and based on bis(4-isocyanatocyclohexyl)methane 1,6-diisocyanatohexane or 1-isocyanato-5-isocyanato-methyl-3,3,5-trimethylcyclohexane.

47. The hybrid reactive resin system according to claim 39, wherein the component (C) comprises a (cyclo)aliphatic or aromatic polyol completely etherified with epichlorohydrin or mono- or polyfunctional glycidyl ether, or a product containing a polyol partially etherified with epichlorohydrin or an hydroxyfunctional mono- or polyfunctional glycidyl ether.

48. The hybrid reactive resin system of claim 39, wherein the component (D) comprises a high-boiling point solvent.

49. The hybrid reactive resin system of claim 48, wherein the high boiling point solvent is N-ethylpyrrolidone, N-methylpyrrolidone, a dipropylene glycol dimethyl ether, a dialkyl adipates or a cyclic alkylene carbonate.

50. The hybrid reactive resin system according to claim 39, wherein the component (E) comprises ethylenediamine, a liquid epoxy resin curing agent formulated ready for use and is based on an aliphatic or aromatic polyamine or polyamidoamine.

51. The hybrid reactive resin system of claim 39, wherein the component (E) is present in coated, microencapsulated, carrier-fixed hydrophilized, or solvent-containing form and optionally may have sustained-release properties.

52. The hybrid reactive resin system of claim 39, wherein the formulation components (F)(i) and (F)(ii) each comprise a reactive inorganic filler selected from the group consisting of cement, calcium oxide, calcium hydroxide and calcium sulphate.

53. The hybrid reactive resin system of claim 39, wherein formulation components (F)(i) or (F)(ii) comprise at least one of a functionalized inorganic or organic filler, a light filler inert to water, a functionalized inorganic or organic pigment, a functionalized inorganic or organic carrier material, a functionalized inorganic or organic nanomaterial, a functionalized inorganic or organic nanocomposite, an inorganic or organic fiber, graphite, carbon black, a carbon fiber, a carbon nanotube, a metal fiber or a metal powder, a conductive organic polymer, a redispersible polymer powder or a superabsorber.

54. The hybrid reactive resin system of claim 39, wherein the formulation components (F)(i) or (F)(ii) each comprise an other additive selected from the group consisting of an antifoaming agent, a deaerator, a lubricating additive, a leveling additive, a substrate wetting additive, a wetting and dispersing additive, a water repellent, a rheology additive, a coalescence auxiliary, a dulling agent, an adhesion promoter, an antifreeze, antioxidant, a UV stabilizer and a biocide.

55. The hybrid reactive resin system of claim 39, wherein formulation components (F)(i) or (F)(ii) the plasticizer is selected from the group consisting of dialkyl phthalate, dialkyl adipiate, biodiesel an rapeseed oil methyl ester.

56. The hybrid reactive resin system of claim 39, wherein component (K)(i) is dibutyltin oxide, dibutyltin dilaurate, triethylamine, tin(II) octanoate, 1,4-diazabicyclo[2.2.2]octane, 1,4-diazabicyclo[3,2,0]-5-nonene, 1,5-diazabicyclo[5,4,0]-7-undecene, or a morpholine derivative.

57. The hybrid reactive resin system of claim 39, wherein the component (K)(ii) comprises benzyldimethyl-amine, or 4-N,N-dimethylaminophenol, 2,4,6-tris(N,N-dimethylaminomethyl)phenol, 2-methylimidazole, 2-phenyl-imidazole, or another suitable tertiary amine.

58. A process for the preparation of the two-component aqueous hybrid reactive resin system according to claim 39, comprising
a) preparing an epoxyfunctional (aqueous) binder component (I) by
a₁) allowing the components (A)(i), (A)(ii) and (B) to react, optionally in the presence of the component (K)(i), the mixture of the components (A)(i) and (B) being reacted either simultaneously or stepwise with the component (A)(ii), and optionally the components (A)(iii), (A)(iv), (A)(v), (C) and wherein (D) is also added to the reaction mixture, and
a₂) optionally the prepolymer from stage a₁) being emulsified or dispersed in water and optionally the formulation component (F)(i) is added, and
b) preparing a latently aminofunctional curing component (II) by combining the components (E), (F)(ii) and (K)(ii) in any desired sequence.

59. The process according to claim 58, wherein the metering of the components (A), (B), (C), (D), (F)(i), (K)(i) used in the stages a) and b) is effected in any desired manner.

60. The process according to claim 58, comprising adjusting the NCO/OH equivalent ratio of the components (A) and (B) in stage a) to 1.2 to 2.5.

61. The process according to claim 58, wherein the stage a₁) is carried out at a temperature of 40 to 90° C.

62. The process according to claim 58, wherein the stage a₂) is carried out at a temperature of 30 to 60° C.

63. The process according to claim 58, wherein the stage b) is carried out at a temperature of 10 to 40° C.

64. The process according to claim 58, wherein in stage a₁ epoxyfunctional binder component (I) which is self-emulsifying without additional anionic and/or nonionic hydrophilization is used in stage a₁).

65. The process according to claim 58, wherein the solids content of the epoxyfunctional aqueous binder component (I) comprising the components (A), (B) and (C) in stage a) is adjusted to 10 to 100% by weight.

66. The process according to claim 58, wherein a solid content of the two-component coating system consisting of the components (I) and (II) is adjusted to 10 to 100% by weight.

67. A composition comprising a substrate coated with two-component aqueous hybrid reactive resin system according to claim 39.

68. The composition of claim 67, wherein the substrate is mineral and nonmineral surface based on concrete, cement, lime, gypsum, anhydrite, geopolymers, glass, wood, a wood-based materials, composite materials, artificial and natural stone, plastic or glass fiber-reinforced plastic a metal or a polymer.

69. The composition of claim 67, wherein the coating system is provided as an antigraffiti coating, an antisoiling coating, a seal, an antislip covering, a dischargeable floor coating system, a balcony coating, an easy-to-clean coating, a leveling and priming of concrete, a fresh concrete coating, a floor coating, a garage coating, a water protection coating system according to §19 WHG, a high-bay warehouse coating according to DIN 15185, a parking floor coating, a PCC coating system, a pipeline coating, a crack-bridging coating system, a hopper coating, a sport floor covering system or a wall coating.

70. The composition of claim 67, wherein the coating system is applied to a total thickness of 0.1 to 50 mm.

71. The composition of claim 67, wherein the coating system is provided in an amount of from 0.1 to 10.0 k g per m² of the substrate area.

72. The composition of claim 67, wherein the substrate is fresh concrete.

73. A process comprising filling a cavity or a crack with the hybrid reactive resin system of claim 39.
